(19) United States
(12) Patent Application Publication
(10) Pub. No.: US 2007/0036155 A1
(43) Pub. Date: Feb. 15, 2007

(54) Bridge apparatus for internet telephone exchange and internet phone system

(76) Inventors: Ing-Kai Huang, Hsinchu City (TW); Douglas Wang, Hsinchu City (TW)

Correspondence Address: HDSL, 4331 STEVENS BATTLE LANE, FAIRFAX, VA, 22033, US

(21) Appl. No.: 11/187,843

(22) Filed: Jul. 25, 2005

(51) Int. Cl. H04L 12/66

(52) U.S. Cl. 370/356

(57) ABSTRACT

A bridge apparatus for Internet telephone exchange and an Internet phone system. The bridge apparatus is connected with a telephone exchange to form an Internet telephone exchange. An ordinary phone can make phone call through the Internet telephone exchange, a router and Internet to a remote Internet phone after the ordinary phone is dialed. Moreover, a remote Internet phone also can make phone call to a local ordinary phone through Internet, the router, the Internet telephone exchange.

### BACKGROUND OF THE INVENTION

1. Field of the Invention

The present invention relates to a bridge apparatus for Internet telephone exchange and an Internet phone system, more particularly to a bridge apparatus for Internet telephone exchange, which enables an ordinary phone with Internet phone function and an Internet phone system.

2. Description of Related Art

The conventional telephones and mobile phones play important roles for communication between people, especially for people with far separation. However, the fee for domestic call, long-distance call, and inter-territorial call is counted on time base, namely, by minute or second, which is usually high for user. Therefore, the service provider usually offers discount period for user, which is a particular time such as midnight.

Moreover, as the prevailing of Internet, Internet phones such as Skype, MSN, AOL, Peer-Call, or IP phone are alternative choices for users. These Internet phones allow people have vocal conversation with remote party at the expense of Internet connection fee only.

However, the existing Internet phones request both parties (calling party and called party) to have the access ability of computer or IP phone, which is inconvenient for user.

### SUMMARY OF THE INVENTION

The present invention is intended to provide a bridge apparatus for Internet telephone exchange, which enables an ordinary phone with Internet phone function and to communicate with a remote Internet phone, thus saving telecommunication cost.

Accordingly, the present invention provides a bridge apparatus for Internet telephone exchange and an Internet phone system. The bridge apparatus is connected with a telephone exchange to form an Internet telephone exchange. An ordinary phone can make phone call with an Internet proprietary protocol phone (such as Skype, MSN, AOL, YAHOO, and Peer-call phone) or an SIP phone through the Internet telephone exchange, a router and Internet to a remote Internet phone after the ordinary phone is dialed. Moreover, a remote Internet phone such as Internet proprietary protocol phone or SIP phone also can make phone call to a local ordinary phone through Internet, the router, the Internet telephone exchange.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows a schematic diagram of an Internet phone system according to a preferred embodiment of the present invention.

FIG. 2 shows a schematic diagram of a bridge apparatus according to a preferred embodiment of the present invention.

FIG. 3 shows a block diagram of a bridge apparatus according to a preferred embodiment of the present invention.

### DETAILED DESCRIPTION OF THE INVENTION

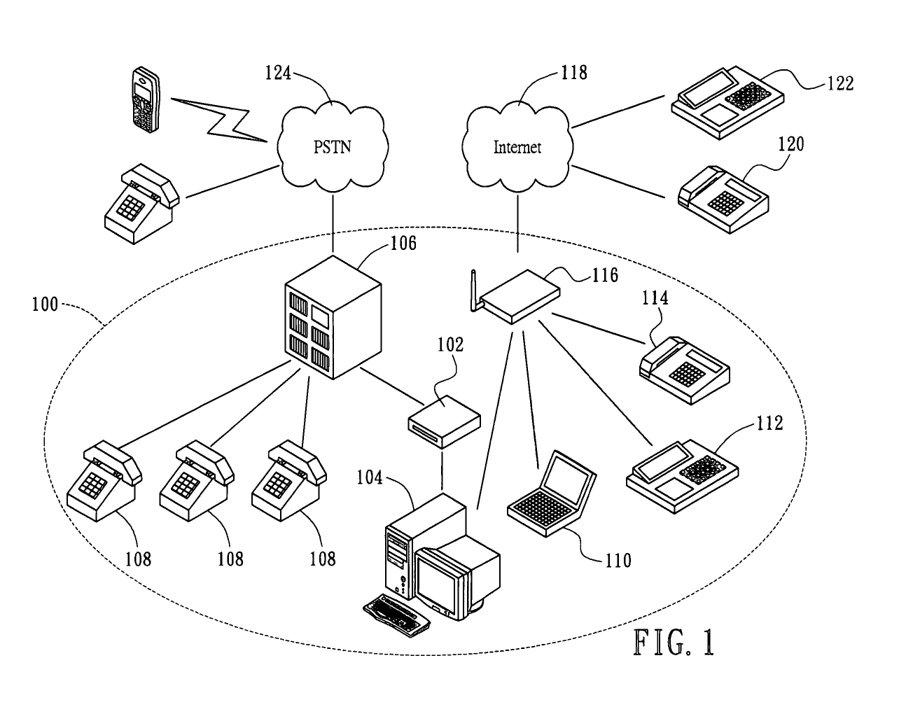

FIG. 1 shows a schematic diagram of an Internet phone system according to a preferred embodiment of the present invention. The Internet phone system 100 comprises at least a bridge apparatus 102, a computer 104, a telephone exchange 106 and a plurality of ordinary telephone sets 108. The bridge apparatus 102 is electrically connected to the telephone exchange 106 to provide Internet phone function to the ordinary telephone set.

The telephone exchange 106 is electrically to ordinary telephone set 108, the Public Switched Telephone Network (PSTN) 124 and the bridge apparatus 102. The telephone exchange 106 is functioned for voice data transfer between the ordinary telephone set 108 and the PSTN 124, which is well known to those skilled in the art and is not stated in detail here.

The computer 104 is connected to a router 116 through a local area network (LAN) and the router 116 is connected to Internet 118 through a wide area network (WAN). The Internet phone connected to the router 116 is, for example but not limited to, Internet proprietary protocol phones 112 such as Skype, MSN, AOL, YAHOO and Peer-call phone 112 or SIP phone 114. Moreover, for the Internet proprietary protocol phones such as Skype, MSN, AOL, YAHOO and Peer-call phone 112, the non-digital account should be converted to numeral before actual dialing and accessing Internet phone.

The bridge apparatus 102 is electrically connected to the telephone exchange 106 and the computer 104 to form a network exchange (as shown in FIG. 1). The computer 110, the Internet proprietary protocol phone 112 and the SIP phone 114 are communicated with a remote Internet proprietary protocol phone 122 and a remote SIP phone 120 through the router 116. The bridge apparatus 102 is connected to the telephone exchange 106 and the computer 104 to form a network exchange such that the ordinary telephone set 108 can communicate with the remote Internet proprietary protocol phone 122 and the remote SIP phone 120 through the telephone exchange 106, the bridge apparatus 102, the computer 104, and the router 116 to the Internet 118, after the ordinary telephone set 108 is dialed.

The remote Internet proprietary protocol phone 122 and the remote SIP phone 120 also can communicate with the ordinary telephone set 108 through the Internet 118, the router 116, and then through the computer 104, the bridge apparatus 102 and the telephone exchange 106.

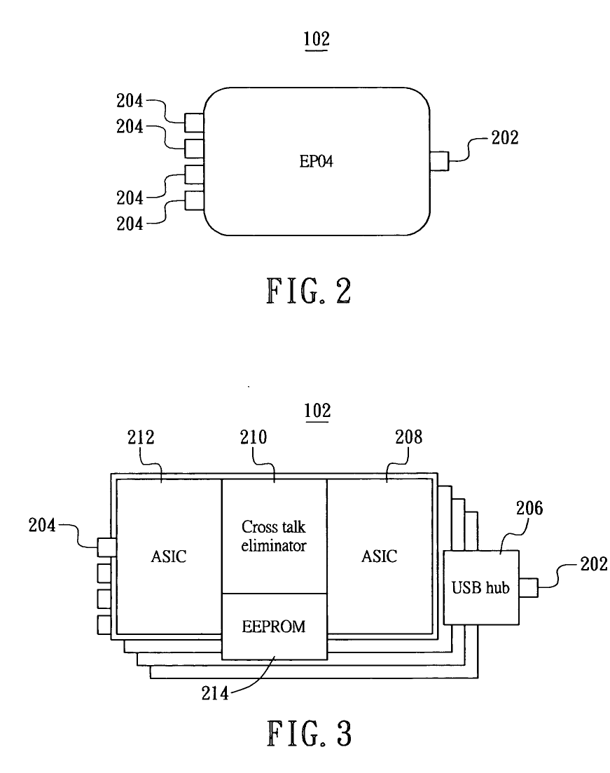

With reference to FIGS. 2 and 3, the bridge apparatus 102 according to a preferred embodiment of the present invention comprises a Universal Serial Bus (USB) connector 202 and a telephone line connector 204. The USB connector 202 is connected to the computer 104 as shown in FIG. 1 and the telephone line connector 204 is connected to the telephone exchange 106 through a telephone line RJ11 as shown in FIG. 1.

The bridge apparatus 102 comprises a USB hub 206, ASICs (Application Specific Integrated Circuit) 208 and 212, a cross talk eliminator 210, a telephone line connector 204 and a memory 214.

The USB hub 206 comprises a USB connector 202 and the USB connector 202 is electrically connected to the computer 104 to receive voice data from the computer 104 or transmit voice data to the computer 104.

The ASIC 208 is electrically connected to the USB hub 206 to receive and transmit voice data and output the voice data after processing the voice data. When the ASIC 208 receives the voice data from the USB hub 206, the ASIC 208 converts the digital voice data to an analog voice data and then outputs the analog voice data to the cross talk eliminator 210. Moreover, when ASIC 208 receives the voice data from the cross talk eliminator 210, the ASIC 208 converts the analog voice data to a digital voice data and then outputs the digital voice data to the USB hub 206.

The cross talk eliminator 210 is electrically connected to the ASIC 208, the ASIC 212 and the memory 214. The cross talk eliminator 210 receives a voice data and output the voice data after removing cross talk from the voice data.

The ASIC 212 is connected to the telephone exchange 106 through the telephone line connector 204 and used to transmit analog voice data.

The memory 214 is used to store the software program and telephone number for the operation of the bridge apparatus 102. The memory 214 is, for example, an EEPROM (Electrically Erasable Programmable Read-Only Memory).

According to a preferred embodiment of the present invention, the bridge apparatus 102 provides accessing ability to Internet 118 and PSTN 124.

To sum up, the bridge unit and network telephone system of the network telephone according to the present invention can link Internet and PSTN to enable user to access Internet phone by using ordinary phone. The current telephone exchange can be upgraded to Internet telephone exchange.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A bridge apparatus electrically connected between a computer and an Internet telephone exchange, the bridge apparatus comprising:
a Universal Serial Bus (USB) hub comprising a USB connector electrically connected to the computer and used to transmit a voice data to and receive a voice data from the computer;
a first Application Specific Integrated Circuit (ASIC) electrically connected to the USB hub and used to receive and transmit the voice data and process the voice data before outputting the voice data; and
a second ASIC electrically connected to the first ASIC to receive and transmit the voice data.

2. The bridge apparatus as in claim 1, further comprising a memory to store at least one software program and at least one telephone number required by bridge apparatus.

3. The bridge apparatus as in claim 2, wherein the memory is an Electrically Erasable Programmable Read-Only Memory (EEPROM).

4. The bridge apparatus as in claim 1, wherein the second ASIC is electrically connected to a telephone line connector and the telephone line connector is electrically connected to the Internet telephone exchange to receive and transmit the voice data.

5. The bridge apparatus as in claim 1, wherein the first ASIC performs a digital to analog conversion for the voice data.

6. The bridge apparatus as in claim 1, wherein the Internet telephone exchange is electrically connected to a plurality of telephone sets and a Public Switched Telephone Network (PSTN).

7. The bridge apparatus as in claim 1, wherein the computer is electrically connected to a local area network.

8. The bridge apparatus as in claim 1, further comprising a cross-talk eliminator electrically connected between the first ASIC and the second ASIC to receive the voice data and remove cross talk from the voice data before outputting the voice data.

9. An Internet telephone system comprising:
a telephone exchange receiving and outputting a voice data;
a computer electrically connected to a local area network for connecting to a remote Internet phone, the computer receiving and transmitting the voice data; and
a bridge apparatus electrically connected to the telephone exchange and the computer for receiving the voice data and outputting the voice data after processing the voice data.

10. The Internet telephone system as in claim 9, wherein the telephone exchange is connected to a plurality of ordinary telephones.

11. The Internet telephone system as in claim 9, wherein the bridge apparatus comprises:
a Universal Serial Bus (USB) hub comprising a USB connector electrically connected to the computer and used to transmit the voice data and receive the voice data from the computer;
a first Application Specific Integrated Circuit (ASIC) electrically connected to the USB hub and used to receive and transmit the voice data and process the voice data before outputting the voice data;
a cross-talk eliminator electrically connected to the first ASIC to receive the voice data and remove cross talk from the voice data before outputting the voice data;
a second ASIC electrically connected to the cross-talk eliminator to receive and transmit the voice data; and
a telephone line connector electrically connected to the second ASIC and the telephone exchange to receive and transmit the voice data.

12. The Internet telephone system as in claim 11, further comprising a memory to store at least one software program and at least one telephone number required by bridge apparatus.

13. The Internet telephone system as in claim 12, wherein the memory is an EEPROM.

14. The Internet telephone system as in claim 11, wherein the first ASIC performs a digital to analog conversion for the voice data.

15. The Internet telephone system as in claim 9, wherein the commuter is connected to a local area network through a router for connecting to a remote Internet phone.
